(19) United States
(12) Patent Application Publication
(10) Pub. No.: US 2018/0158611 A1
(43) Pub. Date: Jun. 7, 2018

(54) CAPACITOR AND METHOD FOR MANUFACTURING THE SAME

(71) Applicant: Murata Manufacturing Co., Ltd., Nagaokakyo-shi (JP)

(72) Inventors: Takeo Arakawa, Nagaokakyo-shi (JP); Noriyuki Inoue, Nagaokakyo-shi (JP); Hiromasa Saeki, Nagaokakyo-shi (JP); Naoki Iwaji, Nagaokakyo-shi (JP)

(21) Appl. No.: 15/888,389

(22) Filed: Feb. 5, 2018

Related U.S. Application Data
(63) Continuation of application No. PCT/JP2016/071562, filed on Jul. 22, 2016.

(30) Foreign Application Priority Data
Aug. 12, 2015 (JP) 2015-159578

(51) Int. Cl. H01G 4/06; H01G 4/005

(52) U.S. Cl. CPC H01G 4/06; H01G 4/005

(57) ABSTRACT

A capacitor that includes a conductive porous base material having a porous portion; a dielectric layer on the porous portion; and an upper electrode on the dielectric layer. In the porous portion of the conductive porous base material, a portion having a base material thickness between pores of 1.2 times or less of a thickness of the dielectric layer exits in 5% or more of the entire porous portion, and the dielectric layer is formed from a compound including atoms having an origin different from an origin of the conductive porous base material.

### CROSS REFERENCE TO RELATED APPLICATIONS

The present application is a continuation of International application No. PCT/JP2016/071562, filed Jul. 22, 2016, which claims priority to Japanese Patent Application No. 2015-159578, filed Aug. 12, 2015, the entire contents of each of which are incorporated herein by reference.

### FIELD OF THE INVENTION

The present invention relates to a capacitor and a method for manufacturing the capacitor.

### BACKGROUND OF THE INVENTION

In recent years, capacitors having higher electrostatic capacitance have been required as electronic devices are mounted with high density. As such a capacitor, for example, Patent Document 1 discloses a stacked solid electrolytic capacitor that includes an anode base material made of a valve action metal and a dielectric oxide film layer provided on a surface of the anode base material, and further includes a solid electrolyte layer stacked on the dielectric oxide film layer and a single plate capacitor element formed with a conductor layer, which is stacked on the solid electrolyte layer. In such a capacitor, the dielectric oxide film is formed by oxidizing a metal (e.g., aluminum) on a surface of a base material, namely, by performing anodic oxidation treatment, as described in, for example, Non-Patent Document 1 or 2.
Patent Document 1: WO 2009/118774
Non-Patent Document 1: Nagata (1983), Aluminum Electrolyte Capacitor with Liquid Electrolyte Cathode, Japan Capacitor Industrial CO., LTD.
Non-Patent Document 2: Surface Science Vol. 19, No. 12, p. 772-780, 1998

### SUMMARY OF THE INVENTION

In order to obtain a capacitor with higher electrostatic capacitance, the present inventors have attempted to increase a surface area of a base material by using a conductive porous base material as a conductive base material to reduce a thickness of a wall of a porous portion (that is, a thickness between pores). Unfortunately, the present inventors have noticed that when a dielectric layer is formed by anodic oxidation treatment, too small thickness of the porous portion does not sufficiently improve electrostatic capacitance. As a result of examining this problem, the present inventors have considered that when the thickness of the wall of the porous portion is too small, all metals in the wall portion become metal oxides (that is, metal of the base material is eroded) and disappear, so that no electrostatic capacitance forming portion cannot be formed in the portion.

It is an object of the present invention to provide a capacitor capable of providing higher electrostatic capacitance by using a conductive porous base material, and a method for manufacturing the capacitor.

As a result of intensive studies, the present inventors have found that it is possible to obtain a capacitor with higher electrostatic capacitance by using a conductive porous base material in which a portion having a base material thickness between pores of a porous portion being 1.2 times or less of a thickness of a dielectric layer, or a portion having a base material thickness between pores of 50 nm or less exits in 5% or more of the entire porous portion of the base material, and by making the dielectric layer as a film other than an anodic oxide film.

According to a first aspect of the present invention, there is provided a capacitor including:

a conductive porous base material having a porous portion;

a dielectric layer on the porous portion; and

an upper electrode on the dielectric layer,

wherein

in the porous portion of the conductive porous base material, a portion thereof having a base material thickness between pores of 1.2 times or less of a thickness of the dielectric layer exits in 5% or more of the entire porous portion, and

the dielectric layer is formed from a compound including atoms having an origin different from an origin of the conductive porous base material.

According to a second aspect of the present invention, there is provided a capacitor including:

a conductive porous base material having a porous portion;

a dielectric layer on the porous portion; and

an upper electrode on the dielectric layer,

wherein

in the porous portion of the conductive porous base material, a portion thereof having a base material thickness between pores of 50 nm or less exits in 5% or more of the entire porous portion, and

the dielectric layer is formed from a compound including atoms having an origin different from an origin of the conductive porous base material.

According to a third aspect of the present invention, there is provided a method for manufacturing a capacitor, the method including:

preparing a conductive porous base material having a porous portion;

forming a dielectric layer on the porous portion of the conductive porous base material without oxidizing the base material; and

forming an upper electrode on a resulting dielectric layer,

wherein in the porous portion, a conductive porous base material is used in which a portion thereof having a base material thickness between pores of 1.2 times or less of a thickness of the dielectric layer to be formed exits in 5% or more of the entire porous portion.

According to a fourth aspect of the present invention, there is provided a method for manufacturing a capacitor, the method including:

preparing a conductive porous base material having a porous portion;

forming a dielectric layer on the porous portion of the conductive porous base material without oxidizing the base material; and

forming an upper electrode on the obtained dielectric layer,

wherein a conductive porous base material is used in which a portion thereof having a base material thickness between pores of 50 nm or less exits in 5% or more of the entire porous portion.

The present invention can provide a capacitor with higher electrostatic capacitance by using a conductive porous base material in which a portion having a base material thickness between pores of a porous portion being 1.2 times or less of a thickness of a dielectric layer, or a portion having a base material thickness between pores of 50 nm or less exits in 5% or more of the entire porous portion of the base material, and by making the dielectric layer as a film other than an anodic oxide film.

### BRIEF EXPLANATION OF THE DRAWINGS

FIG. 1(a) is a schematic sectional view of a capacitor 1 according to an embodiment of the present invention, and FIG. 1(b) is a schematic plan view of a conductive metal substrate of the capacitor 1.

FIG. 2(a) is an enlarged view of a high porosity portion of the capacitor in FIG. 1, and FIG. 2(b) is a diagram schematically illustrating a layer structure in the high porosity portion.

### DETAILED DESCRIPTION OF PREFERRED EMBODIMENTS OF THE INVENTION

A capacitor of the present invention will be described in detail below with reference to the drawings. However, a shape, a placement, and the like of the capacitor and each component of the present embodiment are not limited to those of illustrated examples.

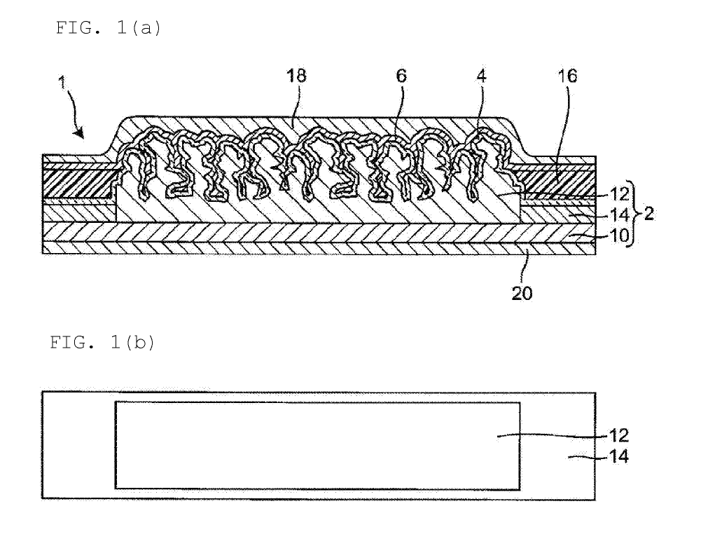

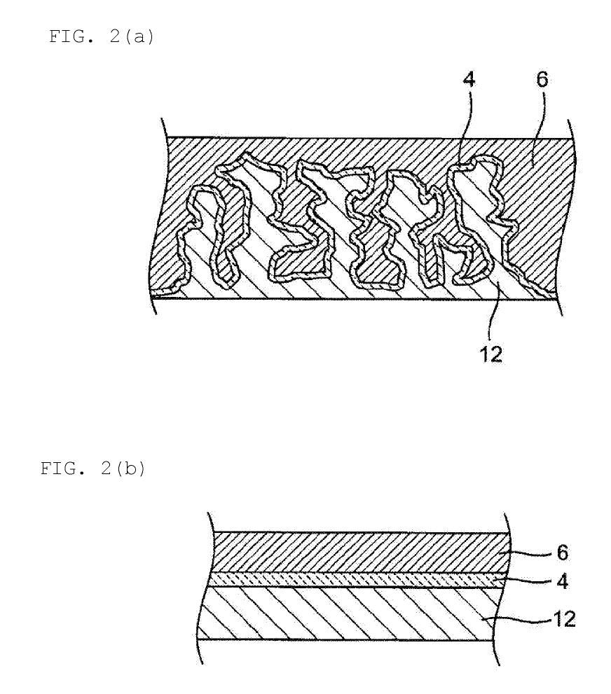

A schematic sectional view of a capacitor 1 of the present embodiment is illustrated in FIG. 1(a), and a schematic plan view of a conductive porous base material 2 is illustrated in FIG. 1(b). In addition, an enlarged view of a high porosity portion 12 of the conductive porous base material 2 is illustrated in FIG. 2(a), and layer structures of the high porosity portion 12, a dielectric layer 4, and an upper electrode 6 is schematically illustrated in FIG. 2(b).

As illustrated in FIGS. 1(a), 1(b), 2(a), and 2(b), a capacitor 1 of the present embodiment has a substantially rectangular parallelepiped shape, and schematically includes a conductive porous base material 2 with a porous portion, a dielectric layer 4 formed on the conductive porous base material 2, and an upper electrode 6 formed on the dielectric layer 4. The conductive porous base material 2 is provided on its one principal surface (first principal surface) side with a high porosity portion (porous portion) 12 having a relatively high porosity and a low porosity portion 14 having a relatively low porosity. The high porosity portion 12 is positioned at the center portion of a first principal surface of the conductive porous base material 2, and the low porosity portion 14 is positioned around the high porosity portion 12. That is, the low porosity portion 14 surrounds the high porosity portion 12. The high porosity portion 12 has a porous structure, and thus corresponds to the porous portion in the present invention. In addition, the conductive porous base material 2 is provided on its other principal surface (second principal surface) side with a support portion 10. That is, the high porosity portion 12 and the low porosity portion 14 constitute the first principal surface of the conductive porous base material 2, and the support portion 10 constitutes the second principal surface of the conductive porous base material 2. In FIG. 1(a), the first principal surface is an upper surface of the conductive porous base material 2, and the second principal surface is a lower surface of the conductive porous base material 2. At an end portion of the capacitor 1, an insulating portion 16 is provided between the dielectric layer 4 and the upper electrode 6. The capacitor 1 includes a first external electrode 18 on the upper electrode 6 and a second external electrode 20 on the principal surface of the conductive porous base material 2 on the support portion 10 side. In the capacitor 1 of the present embodiment, the first external electrode 18 and the upper electrode 6 are electrically connected to each other, and the second external electrode 20 and the support portion 10 are electrically connected to each other. The upper electrode 6 and the high porosity portion 12 of the conductive porous base material 2 face each other with the dielectric layer 4 interposed between the upper electrode 6 and the high porosity portion 12. When the upper electrode 6 and the conductive porous base material 2 are energized, charge can be accumulated in the dielectric layer 4.

The conductive porous base material 2 has a porous structure, and its material and structure are not limited as long as its surface is conductive. For example, the conductive porous base material includes a porous metal base material, a base material formed with a conductive layer on a surface of a porous silica material, a porous carbon material, or a porous ceramic sintered body, and the like. In a preferred aspect, the conductive porous base material is a porous metal base material. When a semiconductor such as Si is used as a base material, it is not preferable because electric resistance is high and equivalent series resistance (ESR) of a capacitor increases.

Metal constituting the porous metal base material includes metal such as aluminum, tantalum, nickel, copper, titanium, niobium, and iron, and an alloy such as stainless steel, duralumin, and the like, for example. Preferably, the porous metal base material is an aluminum porous base material.

The conductive porous base material 2 is provided on its one principal surface (first principal surface) side with the high porosity portion 12 and the low porosity portion 14, and is provided on the other principal surface (second principal surface) side with the support portion 10.

In the present specification, the term “porosity” refers to a proportion of voids occupied in the conductive porous base material. The porosity can be measured as follows. While voids of the porosity portion can be finally filled with the dielectric layer, the upper electrode, or the like in the process of preparing the capacitor, the above “porosity” is calculated by considering a filled portion as a void without reference to a substance filled as described above.

First, the conductive porous base material is processed into a thin piece sample having a thickness of 60 nm or less by a focused ion beam (FIB) micro sampling method. A predetermined region (3 μm×3 μm) of the thin piece sample is measured by scanning transmission electron microscope (STEM)-energy dispersive X-ray spectrometry (EDS) mapping analysis. In a visual field of the mapping measurement, an area where a material constituting the conductive porous base material exists is determined. Then, porosity can be calculated from the following equation. This measurement is performed at three arbitrary regions, and an average value of the measurement values is indicated as the porosity (%).

Porosity (%)=((measurement area−area where material constituting base material exists)/measurement area)×100

In the present specification, the term “high porosity portion” means a portion having a higher porosity than the support portion and the low porosity portion of the conductive porous base material, and corresponds to the porous portion in the present invention.

The high porosity portion 12 has a porous structure. The high porosity portion 12 having a porous structure increases the specific surface area of the conductive porous base material to further increase the electrostatic capacitance of the capacitor.

From the viewpoint of increasing the specific surface area to further increase the electrostatic capacitance of the capacitor, the porosity of the high porosity portion can be preferably 20% or more, more preferably 30% or more, and still more preferably 35% or more. In addition, from the viewpoint of securing mechanical strength, the porosity thereof is preferably 90% or less, and more preferably 80% or less.

Meanwhile, when the porosity is too large, an existing proportion of the base material becomes too small to secure a large surface area. Thus, in a preferable aspect, the existing proportion of the base material is 20% or more, more preferably 25% or more, further preferably 30% or more. The existing proportion of the base material can be calculated from the following equation by measuring a section of the base material, which is obtained by the FIB processing, with STEM-EDS mapping analysis, as in the measurement of the porosity.

Existing proportion (%) of base material=(area where material constituting base material exists/measurement area)×100

While an enlargement ratio of area of the high porosity portion is not particularly limited, the high porosity portion has an enlargement ratio of area that is preferably 30 times or more and 10,000 times or less, more preferably 50 times or more and 5,000 times or less, and is 200 times or more and 600 times or less, for example. Here, the enlargement ratio of area means a surface area per unit projected area. The surface area per unit projected area can be obtained from the amount of adsorption of nitrogen at the liquid nitrogen temperature using a BET specific surface area measuring apparatus.

The enlargement ratio of area can also be obtained by the following method. A scanning transmission electron microscope (STEM) image of a section (a section obtained by being cut in a thickness direction) of a sample is taken entirely with a width X in a thickness (height) T direction (when the image cannot be taken at once, a plurality of images may be joined). Then, a total path length L of a pore surface (a total length of a pore surface) in the obtained section with the width X and the height T is measured. Here, the total path length of the pore surface in a regular quadrangular prism region, the region having the section with the width X and the height T as one side surface and having a surface of the porous base material as one bottom surface, is LX. In addition, an area of the bottom surface of the regular quadrangular prism is X². Thus, the enlargement ratio of area can be obtained as LX/X²=L/X.

In the high porosity portion (i.e., the porous portion), a portion having a base material thickness between pores (i.e., thickness of a wall of the porous portion) of 1.2 times or less thickness of the dielectric layer exits in 5% or more, preferably in 15% or more, and more preferably in 25% or more, of the entire porous portion of the base material. When the portion having a base material thickness between pores of 1.2 times or less thickness of the dielectric layer is set to 5% or more of the entire porous portion of the base material, higher electrostatic capacitance can be secured. In addition, the portion having a base material thickness between pores (i.e., thickness of the wall of the porous portion) of 1.2 times or less thickness of the dielectric layer can exist preferably 80% or less, and more preferably 70% or less, of the entire porous portion of the base material. When the portion having a base material thickness between pores of 1.2 times or less thickness of the dielectric layer is set to 80% or less of the entire porous portion of the base material, the mechanical strength of the porous portion increases to enable reduction in a short circuit failure due to breakage of the capacitor, and electrode resistance is reduced to easily maintain ESR characteristics.

In the high porosity portion (i.e., the porous portion) in an aspect, a portion having a base material thickness between pores (i.e., thickness of a wall of the porous portion) of 50 nm or less, for example, 30 nm or less, or 10 nm or less, exits in 5% or more, preferably in 15% or more, and more preferably in 25% or more, of the entire porous portion of the base material. When the portion having a base material thickness between pores of 50 nm or less is set to 5% or more of the entire porous portion of the base material, higher electrostatic capacitance can be secured. In addition, the portion having a base material thickness between pores (i.e., thickness of the wall of the porous portion) of 50 nm or less, for example, 30 nm or less, or 10 nm or less, can exist preferably 80% or less, and more preferably 70% or less, of the entire porous portion of the base material. When the portion having a predetermined thickness is set to 80% or less of the entire porous portion of the base material, the mechanical strength of the porous portion increases to enable reduction in a short circuit failure due to breakage of the capacitor, and electrode resistance is reduced to easily maintain ESR characteristics.

The thickness of the base material between pores means a thickness of a base material portion between pores (a wall that separates pores) in an image obtained by observing a section of a porous portion of the base material with a TEM, the section being obtained by FIB processing.

A proportion of a portion where the thickness of the base material between pores is equal to or less than a predetermined thickness can be calculated by using the following formula, as follows: an image of a section of the porous portion of the base material obtained by FIB processing, the image being obtained by a TEM, is observed to calculate an area of a portion where the base material exists (pixel unit, hereinafter also referred to as an “initial pixel value”); image processing is applied to the image to eliminate a portion where the base material has a thickness equal to or less than a predetermined value (e.g., a portion having a thickness of 1.2 times or less thickness of the dielectric layer, or a portion having a thickness of 50 nm or less) from the image; and an area of a remaining base material portion (pixel unit, hereinafter also referred to as “processed pixel value”) is calculated.

Proportion of portion having predetermined thickness or less (%)=100−((processed pixel value/initial pixel value)×100)

In the present specification, the term, “low porosity portion”, means a portion having a porosity lower than that of the high porosity portion. Preferably, a porosity of the low porosity portion is lower than a porosity of the high porosity portion, and is equal to or higher than a porosity of the support portion.

The porosity of the low porosity portion is preferably 30% or less, and more preferably 20% or less. In addition, the low porosity portion may have a porosity of 0%. That is, the low porosity portion may or may not have a porous structure. As the low porosity portion decreases in porosity, a capacitor increases in mechanical strength.

The low porosity portion is not an indispensable element in the present invention, and may not be provided. For example, the low porosity portion 14 may not be provided in FIG. 1(a), and the support portion 10 may be exposed upward.

In the present embodiment, while the conductive porous base material includes one principal surface composed of the high porosity portion and the low porosity portion provided around the high porosity portion, the present invention is not limited to this structure. That is, the high porosity portion and the low porosity portion are not particularly limited in existing position, the number of disposition, size, shape, ratio of the both portions, and the like. For example, one principal surface of the conductive porous base material may be composed of only a high porosity portion. In addition, electrostatic capacitance of the capacitor can be controlled by adjusting a ratio of the high porosity portion and the low porosity portion.

The thickness of the high porosity portion 12 is not particularly limited, and can be appropriately determined depending on an object. For example, the thickness may be 2 μm or more, may be preferably 10 μm or more, and may be preferably 1000 μm or less, may be more preferably 300 μm or less, and may be further preferably 50 μm or less, for example. The thickness of the high porosity portion (i.e., thickness of the porous portion) means the thickness of the high porosity portion when assuming that all pores are filled.

The support portion of the conductive porous base material preferably has a smaller porosity to serve as a support. Specifically a porosity of 15% or less is preferable, and substantially no void is more preferable.

While the thickness of the support portion 10 is not particularly limited, the thickness is preferably 1 μm or more, and can be, for example, 3 μm or more, 5 μm or more, or 10 μm or more, in order to increase the mechanical strength of the capacitor. From the viewpoint of reducing height of the capacitor, the thickness is preferably 500 μm or less, and can be 100 μm or less, or 20 μm or less, for example.

The thickness of the conductive porous base material 2 is not particularly limited, and can be appropriately determined depending on an object. For example, the thickness is 3 μm or more, preferably 15 μm or more, and may be 1000 μm or less, preferably 100 μm or less, more preferably 70 μm or less, and further preferably 50 μm or less, for example.

A method for manufacturing the conductive porous base material 2 is not particularly limited. For example, the conductive porous base material 2 can be manufactured by processing a suitable metallic material by a method for forming a porous structure, a method for crushing (filling) a porous structure, a method for removing a porous structure portion, or a method using a combination of the methods above.

A metallic material for manufacturing a conductive porous base material can be a porous metallic material (e.g., etched foil) or a metallic material with no porous structure (e.g., metal foil), or a material acquired by combining these materials. A method of combination is not particularly limited, and includes a method for bonding materials by welding or with a conductive adhesive or the like.

Examples of the method for crushing (filling) a porous structure include, but are not particularly limited to, a method for melting metal by laser irradiation or the like to crush pores, and a method for crushing pores by being compressed by die processing or press working. The laser is not particularly limited, and includes a CO2 laser, a YAG laser, an excimer laser, a fiber laser, and an all-solid pulsed laser such as a femtosecond laser, a picosecond laser, and a nanosecond laser. The all-solid pulsed laser such as a femtosecond laser, a picosecond laser, and a nanosecond laser is preferable because it can more finely control a shape and porosity.

The method for removing a porous structure portion is not particularly limited, and includes dicer processing and ablation processing.

In one of the methods, the conductive porous base material 2 can be manufactured by preparing a porous metallic material and crushing (filling) pores in a portion corresponding to the support portion 10 and the low porosity portion 14 of the porous metal base material.

The support portion 10 and the low porosity portion 14 do not need to be formed at the same time, and they may be separately formed. First, a portion corresponding to the support portion 10 of the porous metallic base material may be processed to form the support portion 10, and then a portion corresponding to the low porosity portion 14 may be processed to form the low porosity portion 14, for example.

In another method, the conductive porous base material 2 can be manufactured by processing a portion corresponding to a high porosity portion of a metal base material (e.g., metal foil) with no porous structure to form a porous structure.

In yet another method, the conductive porous base material 2 with no low porosity portion 14 can be manufactured by crushing pores in a portion corresponding to the support portion 10 of the porous metallic material and removing a portion corresponding to the low porosity portion 14 of the porous metallic material.

In the capacitor 1 of the present embodiment, the dielectric layer 4 is formed on the high porosity portion 12 and the low porosity portion 14.

The dielectric layer in the present invention is formed from a compound consisting of atoms each having an origin different from an origin of the conductive porous base material. Preferably, it is formed by a deposition method. That is, the dielectric layer in the present invention does not substantially contain atoms derived from the conductive porous base material. Thus, an anodic oxidation film obtained by anodic oxidation treatment of oxidizing a surface of the conductive porous base material is excluded from the dielectric layer in the present invention.

While the material forming the dielectric layer 4 is not particularly limited as long as it has insulating properties, metallic oxides such as AlOₓ (e.g., Al₂O₃), SiOₓ (e.g., SiO₂), AlTiOₓ, SiTiOₓ, HfOₓ, TaOₓ, ZrOₓ, HfSiOₓ, ZrSiOₓ, TiZrOₓ, TiZrWPₓ, TiOₓ, SrTiOₓ, PbTiOₓ, BaTiOₓ, BaSrTiOₓ, BaCaTiOₓ, and SiAlOₓ; metallic nitrides such as AlNₓ, SiNₓ, and AlScNₓ; and metallic oxynitrides such as AlOₓN_{y}, SiOₓN_{y}, HfSiOₓN_{y}, and SiCₓO_{y}N_{z} are preferable, and AlOₓ, SiOₓ, SiOₓN_{y}, and HfSiOₓ are more preferable. The formula described above simply expresses structure of the material, and thus does not limit composition thereof. That is, x, y, and z attached to O and N may be any value greater than zero, and an abundance ratio of each element including a metal element is arbitrary.

The thickness of the dielectric layer is not particularly limited, and is preferably 3 nm or more and 100 nm or less, and more preferably 5 nm or more and 50 nm or less, for example. When the thickness of the dielectric layer is set to 3 nm or more, preferably 5 nm or more, insulating properties can be enhanced to reduce leakage current. When the thickness of the dielectric layer is set to 100 nm or less, larger electrostatic capacitance can be obtained.

The dielectric layer is preferably formed by a gas phase method such as a vacuum deposition method, a chemical vapor deposition (CVD) method, a sputtering method, an atomic layer deposition (ALD) method, a pulsed laser deposition (PLD) method, or the like, or a method using a supercritical fluid. The ALD method is more preferable because a more homogeneous and dense film can be formed even in a fine pore of a porous component.

In the capacitor 1 of the present embodiment, the insulating portion 16 is disposed at the end portion of the dielectric layer 4. When the insulating portion 16 is disposed, a short circuit between the upper electrode 6 disposed on the insulating portion 16 and the conductive porous base material 2 can be prevented.

In the present embodiment, while the insulating portion 16 is provided over the entire of the low porosity portion 14, the configuration is not limited to this. The insulating portion 16 may be provided only in a part of the low porosity portion 14, and may be provided to the high porosity portion beyond the low porosity portion.

In addition, the insulating portion 16 is positioned between the dielectric layer 4 and the upper electrode 6 in the present embodiment, but the configuration is not limited to this. The insulating portion 16 may be positioned between the conductive porous base material 2 and the upper electrode 6, and may be positioned between the low porosity portion 14 and the dielectric layer 4, for example.

While the material forming the insulating portion 16 is not particularly limited as long as is has insulating properties, resin with heat resistance is preferable when an atomic layer deposition method is used later. As an insulating material forming the insulating portion 16, various kinds of glass material, ceramic material, polyimide resin, and fluorine resin, are preferable.

While the thickness of the insulating portion 16 is not particularly limited, the thickness is preferably 0.3 or more from the viewpoint of more reliably preventing end-face discharge, and can be 1 μm or more or 10 μm or more, for example. From the viewpoint of reducing height of the capacitor, the thickness is preferably 100 μm or less, and can be 50 μm or less or 20 μm or less, for example.

The insulating portion 16 is not an indispensable element in the capacitor of the present invention, and may not be provided.

In the capacitor 1 of the present embodiment, the upper electrode 6 is formed on the dielectric layer 4 and the insulating portion 16.

While a material constituting the upper electrode 6 is not particularly limited as long as it has insulating properties, Ni, Cu, Al, W, Ti, Ag, Au, Pt, Zn, Sn, Pb, Fe, Cr, Mo, Ru, Pd, and Ta; and alloys thereof such as CuNi, AuNi, and AuSn; metal nitrides such as TiN, TiAlN, TiON, TiAlON and TaN; metal oxynitrides; conductive polymers such as poly-3,4-ethylenedioxythiophene (PEDOT), polypyrrole, and polyaniline; and the like, are preferable, and TiN and TiON are more preferable.

The thickness of the upper electrode is not particularly limited, and is preferably 3 nm or more, and more preferably 10 nm or more, for example. When the thickness of the upper electrode is set to 3 nm or more, the resistance of the upper electrode itself can be reduced.

The upper electrode may be formed by an ALD method. When the ALD method is used, electrostatic capacitance of the capacitor can be increased. Alternatively, the upper electrode may be formed by a method such as a chemical vapor deposition (CVD) method, plating, bias sputtering, a Sol-Gel method, and filling with an electroconductive polymer, which can cover the dielectric layer and can substantially fill pores of a conductive porous base material. Preferably, the upper electrode may be formed as follows: a conductive film is formed on the dielectric layer by the ALD method; and pores are filled with a conductive material, preferably a substance with a lower electrical resistance, from above the conductive film by another method. This configuration can efficiently provide a higher electrostatic capacitance density and a lower ESR. It is not necessary that voids are completely filled with the upper electrode, and some voids may remain. In addition, the voids may be filled with resin, glass, or the like.

When the upper electrode does not have sufficient conductivity as a capacitor electrode after being formed, an extended electrode layer composed of Al, Cu, Ni, and the like may be additionally formed on a surface of the upper electrode by sputtering, vapor deposition, plating, or the like.

In the present embodiment, the first external electrode 18 is formed on the upper electrode 6.

In the present embodiment, the second external electrode 20 is formed on a principal surface of the conductive porous base material 2 on the support portion 10 side.

While a material constituting the first external electrode 18 and the second external electrode 20 is not particularly limited, a metal such as Au, Pb, Pd, Ag, Sn, Ni, and Cu, and alloys thereof, and a conductive polymer, are preferable, for example. A method for forming the first external electrode is not particularly limited, and a CVD method, electrolytic plating, electroless plating, vapor deposition, sputtering, baking of a conductive paste, and the like can be used, for example, and the electrolytic plating, the electroless plating, the vapor deposition, the sputtering, and the like are preferable.

While the first external electrode 18 and the second external electrode 20 are disposed over the entire upper and lower surfaces of the capacitor, the present invention is not limited to this, and the first external electrode 18 and the second external electrode 20 can be disposed only in a part of each surface of the capacitor in any shape and size. In addition, the first external electrode 18 and the second external electrode 20 are not indispensable elements, and may not be provided. In this case, the upper electrode 6 also functions as a first external electrode and the support portion 10 also functions as a second external electrode. That is, the upper electrode 6 and the support portion 10 may function as a pair of electrodes. In this case, the upper electrode 6 may function as an anode, and the support portion 10 may function as a cathode. Alternatively, the upper electrode 6 may function as a cathode and the support portion 10 may function as an anode.

In the present embodiment, thickness of an end portion (preferably a peripheral portion) of the capacitor can be equal to or less than thickness of a central portion thereof, and can be preferably equal thereto. In the end portion, many layers are stacked, and thickness is liable to change due to cutting, so that a variation in the thickness can be increased. Thus, reducing the thickness of the end portion enables influence on an external size (particularly thickness) of the capacitor to be reduced. Meanwhile, the thickness of the end portion may be larger than the thickness of the central portion.

In the present embodiment, while the capacitor has a substantially rectangular parallelepiped shape, the present invention is not limited to this. The capacitor of the present invention can have any shape, and may have a planar shape of a circle, an ellipse, a rectangle with rounded corners, or the like, for example.

While the capacitor 1 of the present embodiment is described above, various modifications can be made to the capacitor of the present invention.

For example, a layer for increasing adhesion between layers, or a buffer layer for preventing diffusion of components between the respective layers may be provided between the respective layers. Further, a protective layer may be provided on a side surface of the capacitor or the like.

In the above embodiment, while the conductive porous base material 2, the dielectric layer 4, the insulating portion 16, and the upper electrode 6 are disposed in this order in the end portion of the capacitor, the present invention is not limited to this. For example, the order of disposition is not particularly limited as long as the insulating portion 16 is positioned between the upper electrode 6 and the conductive porous base material 2. For example, the conductive porous base material 2, the insulating portion 16, the dielectric layer 4, and the upper electrode 6 may be disposed in this order.

In addition, while the capacitor 1 of the above embodiment includes the upper electrode and the outer electrode that are provided up to an edge of the capacitor, the present invention is not limited to this. In an aspect, the upper electrode (preferably the upper electrode and the first external electrode) is disposed away from the edge of the capacitor. This disposition enables end-face discharge to be prevented. That is, the upper electrode does not need to be formed so as to cover the entire of the conductive porous base material, and the upper electrode may be formed so as to cover only the high porosity portion.

Further, the capacitor of the present invention is provided on only its one principal surface with a porous portion, but may be provided on its both principal surfaces with respective porous portions with a support portion interposed therebetween.

The capacitor of the present invention can be obtained by using a conductive porous base material in which a portion having a base material thickness between pores of a porous portion being 1.2 times or less thickness of the dielectric layer to be formed, or a portion having a base material thickness between pores of 50 nm or less exits in 5% or more of the entire porous portion of the base material, and by forming the dielectric layer by a method other than an anodic oxidation treatment.

That is, in an aspect, the capacitor of the present invention can be manufactured by a method including:

preparing a conductive porous base material having a porous portion;

forming a dielectric layer on the porous portion by an atomic layer deposition method without substantially oxidizing the base material; and

forming an upper electrode on the obtained dielectric layer,

wherein in the porous portion, a conductive porous base material is used in which a portion having a base material thickness between pores of 1.2 times or less thickness of the dielectric layer to be formed exits in 5% or more of the entire porous portion.

In another aspect, the capacitor of the present invention can be manufactured by a method including:

preparing a conductive porous base material having a porous portion;

forming a dielectric layer on the porous portion by an atomic layer deposition method without substantially oxidizing the base material; and

forming an upper electrode on the obtained dielectric layer,

wherein in the porous portion, a conductive porous base material is used in which a portion having a base material thickness between pores of 50 nm or less exits in 5% or more of the entire porous portion.

Preferably, in each of the manufacturing methods described above, the dielectric layer is formed by a gas phase method such as a vacuum deposition method, a chemical vapor deposition (CVD) method, a sputtering method, an atomic layer deposition (ALD) method, a pulsed laser deposition (PLD) method, or the like, or a method using a supercritical fluid. More preferably, the dielectric layer is formed by the atomic layer deposition method.

### EXAMPLES

### Example 1

As a conductive porous base material, used was an aluminum etched foil provided only on its one surface with a porous portion (a porous portion having a thickness of 60 μm), the aluminum etched foil having a thickness of 100 μm and a specific surface area of 6 m²/g.

The aluminum etched foil used was processed into a thin piece by FIB processing using a focused ion beam device (SM 13050 SE, manufactured by SII Nano Technology Co., Ltd.) such that the thin piece had a thickness of about 50 nm. An FIB damage layer generated during the foil was processed into a thin piece was removed by using an Ar ion milling apparatus (PIPS model 1691 manufactured by GATAN). A section of the porous portion of the aluminum etched foil obtained by the FIB processing was observed with a TEM (JEM-2200FS, manufactured by JEOL Ltd.) in a region of 3 μm×3 μm. As a result of measuring an area of the entire image of the region in the central portion of the section of the porous portion, the area was 226572 pixels. In addition, as a result of measuring an area of a portion of an aluminum base material for predetermined three places in this image, an average area of the three places was 91964 pixels. Further, as a result of measuring an area of a remaining base material portion obtained by erasing a region where the base material had a thickness of 48 nm or less through processing the TEM image, an average area of the three places was 84762 pixels.

Subsequently, an Al₂O₃ film having a thickness of 40 nm was formed on the porous portion as a dielectric layer by an atomic layer deposition method. Subsequently, a TiN film having a thickness of 100 nm was formed as an upper electrode by an atomic layer deposition method. In addition, a Cu plating film having a thickness of 2 μm was formed on the upper electrode by a plating method, and then a capacitor of Example 1 was obtained.

### Comparative Example 1

A capacitor of Comparative Example 1 was prepared in the same manner as in Example 1 except that a dielectric layer was formed by an anodic oxidation method.

### Test Example

For each of the capacitors of Example 1 and Comparative Example 1 prepared above, electrostatic capacitance was measured by an AC impedance method. Results are shown in Table 1. As with the aluminum etched foil, each of the capacitors was also measured for an existing proportion of the base material in the porous portion (an existing proportion of the base material) and a proportion of a portion having a thickness of 1.2 times or less (48 nm or less) thickness of the dielectric layer (a ratio of 1.2 times or less), and results are shown together in Table 1.

TABLE 1

| | | | Existing | |
|---|---|---|---|---|
| | Method for | Electrostatic | proportion of | Proportion of |
| | forming | capacitance | base material | 1.2 times or |
| | dielectric layer | (μF/mm³) | (%) | less (%) |
| Base | — | — | 41 | 8 |
| material | | | | |
| Example 1 | ALD | 24 | 41 | 8 |
| Comparative | Anodic | 21 | 37 | 3 |
| Example 1 | oxidation | | | |

From the above results, in the case of using a conductive porous base material in which a portion having a base material thickness between pores of 1.2 times or less thickness of the dielectric layer exits in about 8% of the entire porous portion, it was confirmed that electrostatic capacitance obtained by using the atomic layer deposition method was about 14% higher than that obtained by using anodic oxidation. It is presumed that this is because in the atomic layer deposition method, the base material is not eroded, and the existing proportion of the base material as well as the proportion of 1.2 times or less do not change before and after the formation of the dielectric layer, whereas in the anodic oxidation method, a thin portion of the base material is eroded (melted) and the portion cannot function as an electrostatic capacitance forming portion.

### Examples 2 to 18

Capacitors of Examples 2 to 18 were produced in the same manner as in Example 1 except that the base materials used were changed to base materials shown in Table 2.

### Comparative Example 2

A capacitor of Comparative Example 2 was produced in the same manner as in Example 1 except that the base material used was changed to a base material shown in Table 2.

### Test Example

In the same manner as described above, the prepared capacitor was measured for the existing proportion of the base material, the electrostatic capacitance, and the proportion of 1.2 times or less. Results are shown in Table 2 below.

TABLE 2

| | | | | Portion having wall | | |
|---|---|---|---|---|---|---|
| | | | | thickness of 1.2 times | Proportion | Electrostatic |
| | Metal species | Material of | Thickness of | or less thickness of | of base | capacitance |
| | of base | dielectric | dielectric film | dielectric layer | material | density |
| Examples | material | layer | nm | % | % | μF/mm3 |
| Comparative | Al | Al2O3 | 30 | 3 | 16 | 15 |
| Example 2 | | | | | | |
| Example 2 | Al | Al2O3 | 30 | 5 | 57 | 19 |
| Example 3 | Al | Al2O3 | 30 | 8 | 41 | 24 |
| Example 4 | Al | Al2O3 | 30 | 12 | 28 | 28 |
| Example 5 | Al | Al2O3 | 30 | 19 | 28 | 30 |
| Example 6 | Al | Al2O3 | 30 | 30 | 58 | 35 |
| Example 7 | Al | Al2O3 | 30 | 60 | 63 | 51 |
| Example 8 | Al | Al2O3 | 30 | 67 | 71 | 47 |
| Example 9 | Al | Al2O3 | 30 | 30 | 20 | 36 |
| Example 10 | Al | Al2O3 | 30 | 55 | 75 | 50 |
| Example 11 | Al | Al2O3 | 30 | 14 | 17 | 23 |
| Example 12 | Al | Al2O3 | 30 | 19 | 36 | 31 |
| Example 13 | Al | SiO2/SiN/SiO2 | 40 | 30 | 58 | 26 |
| Example 14 | Al | SiO2 | 30 | 26 | 48 | 27 |
| Example 15 | Ni | SiO2 | 30 | 30 | 58 | 30 |
| Example 16 | Cu | SiO2 | 30 | 31 | 43 | 31 |
| Example 17 | Ta | SiO2 | 30 | 32 | 44 | 31 |
| Example 18 | Al | SiO2/AlOx | 40 | 23 | 47 | 28 |

As shown in Table 2, it was confirmed that the capacitor of the present invention, in which a portion having a base material thickness between pores of 1.2 times or less thickness of the dielectric layer exits in 5% or more of the entire porous portion, has a higher electrostatic capacitance density than that of Comparative Example 2 where the portion exists in 3% thereof.

In another test, it was confirmed that a short circuit failure occurred in a capacitor having a proportion of the base material of 15% or less, even when the thickness of the base material was within the range of the invention of the present application. This is probably because a small amount of the base material causes a decrease in strength of the conductive porous base material.

The capacitor of the present invention has high electrostatic capacitance, and thus is suitably used for various electronic devices. The capacitor of the present invention is mounted on a substrate to be used as an electronic component. Alternatively, the capacitor of the present invention is embedded in a substrate or an interposer to be used as an electronic component.

### DESCRIPTION OF REFERENCE SYMBOLS

1: capacitor
2: conductive porous base material
4: dielectric layer
6: upper electrode
10: support portion
12: high porosity portion (porous portion)
14: low porosity portion
16: insulating portion
18: first external electrode
20: second external electrode

1. A capacitor comprising:
a conductive porous base material having a porous portion;
a dielectric layer on the porous portion; and
an upper electrode on the dielectric layer,
wherein
in the porous portion of the conductive porous base material, a portion thereof having a base material thickness between pores of 1.2 times or less of a thickness of the dielectric layer exits in 5% or more of the entire porous portion, and
the dielectric layer is formed from a compound including atoms having an origin different from an origin of the conductive porous base material.

2. The capacitor according to claim 1, wherein the portion having the base material thickness between pores of 1.2 times or less of the thickness of the dielectric layer is 15% or more.

3. The capacitor according to claim 1, wherein the portion having the base material thickness between pores of 1.2 times or less of the thickness of the dielectric layer is 25% or more.

4. The capacitor according to claim 1, wherein an existing proportion of the base material is 17% or more in the porous portion of the conductive porous base material.

5. The capacitor according to claim 1, wherein the dielectric layer is a gas phase-formed dielectric layer or a supercritical fluid-formed dielectric layer.

6. The capacitor according to claim 1, wherein the dielectric layer is an atomic layer deposited dielectric layer.

7. A capacitor comprising:
a conductive porous base material having a porous portion;
a dielectric layer on the porous portion; and
an upper electrode on the dielectric layer,
wherein
in the porous portion of the conductive porous base material, a portion thereof having a base material thickness between pores of 50 nm or less exits in 5% or more of the entire porous portion, and
the dielectric layer is formed from a compound including atoms having an origin different from an origin of the conductive porous base material.

8. The capacitor according to claim 7, wherein the portion having the base material thickness between pores of 50 nm or less is 15% or more.

9. The capacitor according to claim 7, wherein the portion having the base material thickness between pores of 50 nm or less is 25% or more.

10. The capacitor according to claim 7, wherein an existing proportion of the base material is 17% or more in the porous portion of the conductive porous base material.

11. The capacitor according to claim 7, wherein the dielectric layer is formed a gas phase-deposited dielectric layer or a supercritical fluid-deposited dielectric layer.

12. The capacitor according to claim 7, wherein the dielectric layer is an atomic layer deposited dielectric layer.

13. A method for manufacturing a capacitor, the method comprising:
preparing a conductive porous base material having a porous portion;
forming a dielectric layer on the porous portion of the conductive porous base material without oxidizing the base material; and
forming an upper electrode on the dielectric layer,
wherein in preparing the conductive porous base material, a material is used in which a portion of the porous portion has a base material thickness between pores of 1.2 times or less of a thickness of the dielectric layer to be formed exits in 5% or more of the entire porous portion.

14. The method for manufacturing a capacitor according to claim 13, wherein the dielectric layer is formed by an atomic layer deposition method.

15. The method for manufacturing a capacitor according to claim 13, wherein the portion of the porous portion having the base material thickness between pores of 1.2 times or less of the thickness of the dielectric layer to be formed is 15% or more.

16. The method for manufacturing a capacitor according to claim 13, wherein the portion of the porous portion having the base material thickness between pores of 1.2 times or less of the thickness of the dielectric layer to be formed is 25% or more.

17. A method for manufacturing a capacitor, the method comprising:
preparing a conductive porous base material having a porous portion;
forming a dielectric layer on the porous portion of the conductive porous base material without oxidizing the base material; and
forming an upper electrode on the dielectric layer,
wherein in preparing the conductive porous base material, a material is used in which a portion of the porous portion having a base material thickness between pores of 50 nm or less exits in 5% or more of the entire porous portion.

18. The method for manufacturing a capacitor according to claim 17, wherein the dielectric layer is formed by an atomic layer deposition method.

19. The method for manufacturing a capacitor according to claim 17, wherein the portion of the porous portion having the base material thickness between pores of 50 nm or less is 15% or more.

20. The method for manufacturing a capacitor according to claim 17, wherein the portion of the porous portion having the base material thickness between pores of 50 nm or less is 25% or more.
